(19) United States
(12) Patent Application Publication
(10) Pub. No.: US 2009/0144509 A1
(43) Pub. Date: Jun. 4, 2009

(54) MEMEORY SHARING BETWEEN TWO PROCESSORS

(76) Inventors: Kean Wong, Redwood City, CA (US); Karl Townsend, Los Altos, CA (US)

Correspondence Address: FOLEY & LARDNER LLP, 777 EAST WISCONSIN AVENUE, MILWAUKEE, WI, 53202-5306, US

(21) Appl. No.: 11/948,825

(22) Filed: Nov. 30, 2007

(51) Int. Cl. G06F 12/00

(52) U.S. Cl. 711/147; 711/E12.001

(57) ABSTRACT

A wireless device includes a memory having a data port configured to facilitate access to the memory and at least two processing units which are configured to share the memory. The device also includes an arbiter (separate from at least one of the processing units) configured to facilitate sharing of the memory. One or both of the processing units interacts with the arbiter as if the arbiter was the memory. The wireless device could also include one or more additional processing units, which additional processing units may share access to the memory (e.g. facilitated by the arbiter).

### BACKGROUND

The present disclosure relates generally to the field of memory access by a processor. The disclosure more specifically relates to memory sharing between processors.

Handheld devices such as cellular phones and personal digital assistants (PDAs) typically are configured to execute instructions related to both communication over a network (e.g., cellular network, WiFi network, etc) and local applications (e.g., a calendar, media playback, etc.). Some of these handheld devices may include multiple microprocessors for executing these different types of instructions, for example a dedicated communications processor (e.g., a modem) and a local applications processor. In such a configuration, each microprocessor is connected to at least one of its own dedicated memories.

### BRIEF DESCRIPTION OF THE DRAWINGS

FIG. 1 is a system component block diagram of a device according to one exemplary embodiment;

FIG. 2 is an application diagram of the device of FIG. 1 according to an exemplary embodiment;

FIG. 3 is a block diagram of a memory management system in the device of FIG. 1 according to an exemplary embodiment;

FIG. 4 is a block diagram of a memory management system in the device of FIG. 1 according to another exemplary embodiment;

FIG. 5 is a block diagram of a memory management system in the device of FIG. 1 according to another exemplary embodiment;

FIG. 6 is a block diagram of a memory management system in the device of FIG. 1 according to another exemplary embodiment;

FIG. 7 is a flow chart of a memory management method in the device of FIG. 1 according to an exemplary embodiment;

FIGS. 8A-F illustrate a device including the components of FIG. 1 according to an exemplary embodiment.

### DETAILED DESCRIPTION OF THE EXEMPLARY EMBODIMENTS

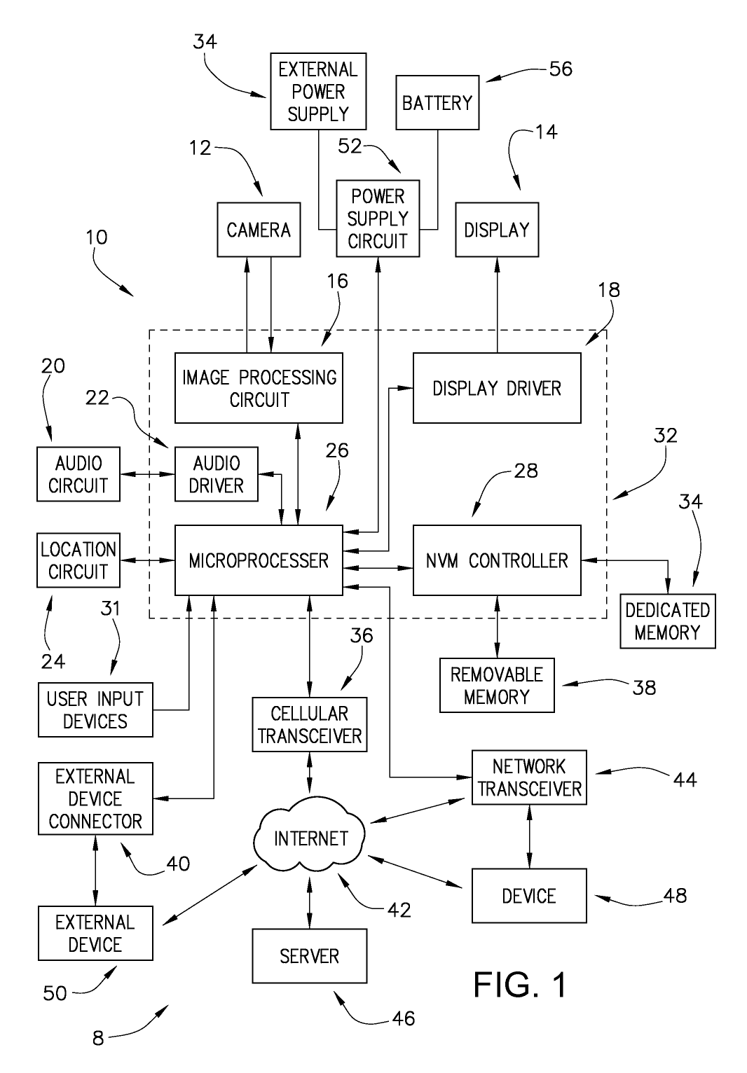

Referring to FIG. 1, a system 8 includes portable electronic device 10 capable of both processing communication over a network 42 (e.g. a wide area network such as the Internet, a local area network, a cellular network, etc.) and processing local applications. Device 10 may include multiple microprocessors 26 (e.g., a communications processor and an application processor) that access one or more external memory structures such as memory 34. Memory access and sharing of the memory structures are controlled by a memory manager or arbiter, which may be integrated with one of microprocessors 26 or embodied as a separate chip. The arbiter may assign priority to microprocessors 26 and grant access to the memory based on the priorities.

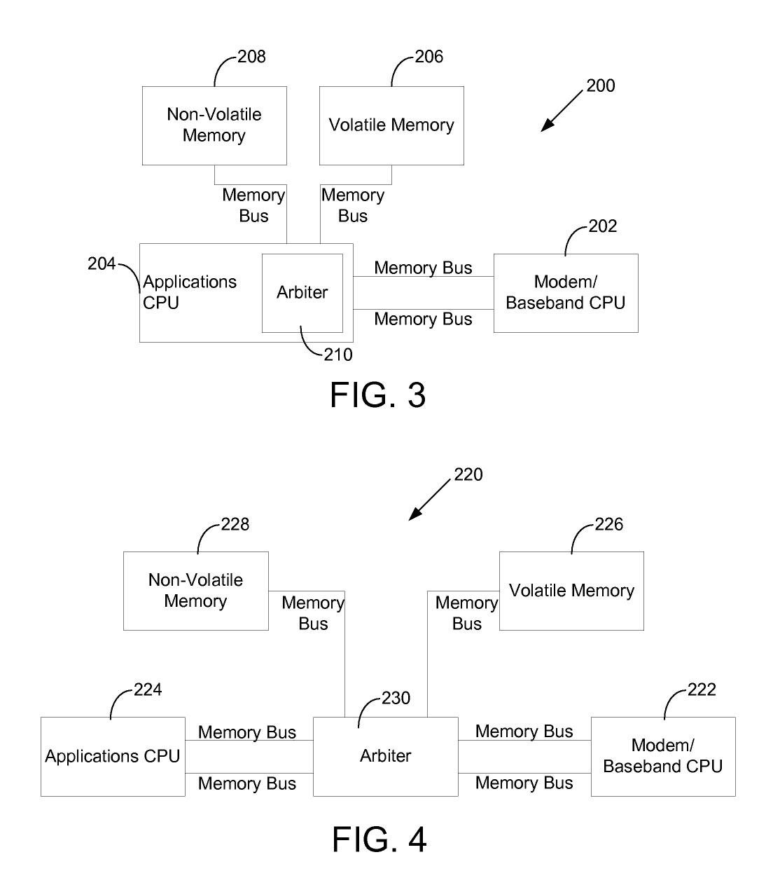

Referring to FIG. 3, a memory management system 200 is configured to provide memory access to multiple processing units. Memory management system 200 generally includes a first processing unit 202, a second processing unit 204, a volatile memory 206, and a non-volatile memory 208. Second processing unit 204 includes an arbiter or memory manager block 210 to manage memory accesses to volatile memory 206 and/or non-volatile memory 208.

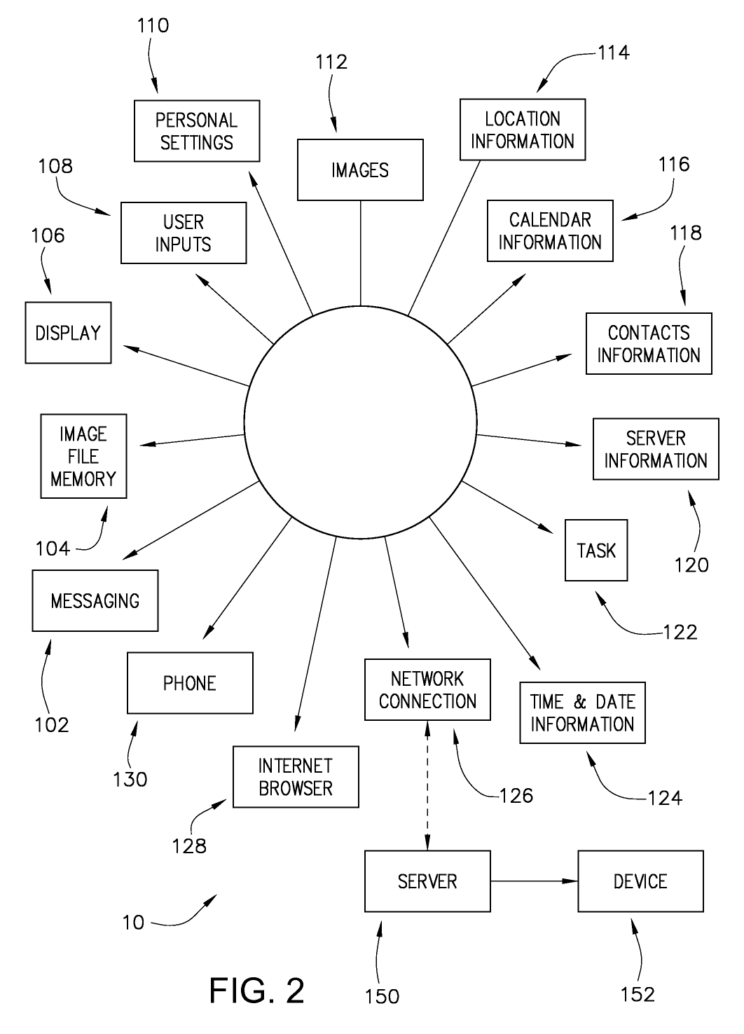

According to one exemplary embodiment, first processing unit 202 may be a modem circuit, a baseband CPU, any other microprocessor or other circuit capable of facilitating communication between device 8 and network 42, and/or any other microprocessor or circuit which provides a function other than facilitating communication with a network. First processing unit 202 may also include a digital signal processing (DSP) circuit. According to this embodiment, second processing unit 204 may be an applications CPU configured to run locally installed applications of device 8 (see, e.g., the applications described with respect to FIGS. 1 and 2), a general purpose processor, or any other microprocessor or other circuit capable of carrying out logic (e.g. instructions) using data stored in a memory. In some embodiments, first processing unit 202 may execute an instruction that is not directly related to communication (and/or facilitating communication) with network 42. According to some exemplary embodiments, first processing unit 202 or second processing unit 204 may be a graphics processor. According to some exemplary embodiments, first or second processing units 202, 204 may be any processor that may use more than about one megabyte, more than two megabytes, more than four megabytes, more than six megabytes, more than eight megabytes, more than ten megabytes, more than 16 megabytes, more than 25 megabytes, more than 32 megabytes, more than 50 megabytes, more than 64 megabytes, more than 75 megabytes, and/or more than 100 megabytes of memory space from either volatile memory 206 or non-volatile memory 208, and/or from each of the volatile and non-volatile memories.

Volatile memory 206 is generally configured to provide data access to arbiter 210 via a data port that includes multiple pins to facilitate data communication. Volatile memory 206 may be a random access memory (RAM) such as a synchronous dynamic random access memory (SDRAM), a double-data-rate SDRAM (DDR SDRAM or DDRAM), a direct rambus or rambus DRAM (DRDRAM or RDRAM), a static random access memory (SRAM), a dual-port RAM, or any other type of random access memory.

Non-volatile memory 208 is generally configured to provide data access to arbiter 210 via a data port that includes multiple pins to facilitate data communication. Non-volatile memory 208 may be a read-only memory (ROM), random access memory (RAM), and/or a rewritable memory. Memory 208 may any type of memory such as a NAND flash memory, NOR flash memory, programmable random access memory (PROM), erasable PROM (EPROM), electronically erasable PROM (EEPROM), a disk drive, or any other type of non-volatile memory.

Arbiter 210 is coupled to the data ports of volatile memory 206 and non-volatile memory 208 and facilitates access and/or sharing of the memories by first processing unit 202 and second processing unit 204. Arbiter 210 is integrated with second processing unit 204 and includes a pin configuration similar to that of an external volatile and non-volatile memory so that arbiter 210 appears as dedicated volatile and non-volatile memories to first processing unit 202. The pins connected to first processing unit 202 may appear to first processing unit 202 as would be expected in a direct connection with a volatile and/or non-volatile memory, thus making arbiter 210 “transparent” to first processing unit 202 by mimicking the data port of the memory. For example, arbiter 210 may appear to be in a refresh state (e.g. self-refresh state) when first processing unit 202 is in a stand-by mode. As another example, arbiter 210 may be configured to provide data to processing unit 202 within 1000 cycles (e.g. within 900, within 800, within 700, within 600, within 500, within 400, within 300, within 200, within 100, within 75, within 50, within 25, within 20, within 15, within 10, within 5, and/or within 3 cycles—e.g. clock cycles) of the time that memory 206, 208 would provide that data if directly connected to processing unit 210. While the cycles listed above are preferably the cycles of the processing unit accessing the memory, the cycles listed above can be judged from any one of a clock cycle of the processing unit accessing the memory, a cycle associated with the memory from which data is being accessed, a cycle associated with the arbiter, etc.).

Arbiter 210 may assign a priority to data transfer or memory accesses of first processing unit 202 and/or second processing unit 204. Thus, if there is a memory or address conflict, arbiter 210 may allow exclusive access or first access to that memory (in a single-port memory) or address (e.g., in a dual-port memory) by the processing unit with the highest priority. The processing unit with the lower priority may be provided limited access to the memory and/or be prevented from transferring data to and/or from the memory or address assigned to the processing unit with the highest priority. Arbiter 210 may include a data buffer configured to store memory access requests and/or data to write to memory from the processing unit with the lower priority until the processing unit with the higher priority is finished accessing the conflicting memory or address.

Arbiter 210 may determine whether a processing unit is in an operational or active state (and/or not in an active state) and assign priority based on this determination. For example, if first processing unit 202 is determined to be in an operational state, arbiter 210 may assign priority to first processing unit 202 when there is a conflict with second processing unit 204 regarding a memory or memory address. In this example, if first processing unit 202 is not in the operational state or is in a non-operational state (e.g., a stand-by mode, a low power mode, etc.), arbiter 210 may assign priority to second processing unit 204. If arbiter 210 determines that first processing unit 202 is in a non-operational state, arbiter 210 may provide an output to first processing unit 202 that is comparable to an output of volatile memory 206 or non-volatile memory 208 when that memory 206,208 is in a non-operational state (e.g. a self-refresh state) so that arbiter 210 is “transparent” to first processing unit 202.

Arbiter 210 may also be configured to assign priority based on a portion of memory 206,208 (e.g. a memory block) being accessed by a processing unit 202,204. For example, if processing unit 204 is accessing an area of memory 208 that contains a time sensitive program, processing unit 204 may be given priority, while processing unit 202 may be given priority in all other circumstances when processing unit 202 is in an operational state. As another example, arbiter 210 may be configured to have priority associated with any number of different programs in a hierarchy (e.g. may assign priority based on a hierarchy of at least 4, at least 6, at least 8, and/or at least 10 different portions of memory accessed by a processing unit).

Arbiter 210 is typically configured to provide a data transfer rate from volatile memory 206 and/or non-volatile memory 208 to first processing unit 202 or second processing unit 204 faster than the data transfer rate required by the processing unit so as to provide increased data integrity. According to one exemplary embodiment, the data transfer from the memory to a processing unit via arbiter 210 may occur at a rate less than ten clock cycles longer than the amount of time it would take to transfer the data directly from the memory to the processing unit. According to another exemplary embodiment, the data transfer via arbiter 210 may occur at a rate less than four clock cycles longer than the time it would take to transfer the data directly from the memory to the processing unit. According to another exemplary embodiment, the data transfer via arbiter 210 may occur at a rate of one clock cycle longer than the time it would take to transfer the data directly from the memory to the processing unit. According to another exemplary embodiment, the data transfer via arbiter 210 may occur in the same amount of time as the time it would take to transfer the data directly from the memory to the processing unit.

Arbiter 210 may also be configured to keep the portions of memories 206, 208 accessed by each processing unit 202, 204 separate from each other. For example, arbiter 210 may be configured to deny memory requests from one of processing units 202, 204 to an area of memory used by the other of processing units 202, 204. The areas of memory allowed to be used by each processing unit 202, 204 may be static (e.g. fixed by arbiter 210) or may be dynamic (e.g. reassignable by arbiter 210).

According to various exemplary embodiments, arbiter 210 may be any combination of digital and/or analog logic that is capable of facilitating memory access to more than one processing unit. While the illustrated embodiments show management of two memories, according to other exemplary embodiments, the system may include and manage access to more than two memories (e.g. at least three, at least four, and/or at least five memories) or to a single memory. Also, while the illustrated embodiments show access by two memory access devices (e.g. processing units), according to other exemplary embodiments, the system may configured to allow access by more than two memory access devices (e.g. at least three, at least four, and/or at least five memory access devices).

Referring to FIG. 4, a memory management system 220 is similar to memory management system 200 of FIG. 3 and is configured to provide memory access to multiple processing units. Memory management system 220 generally includes a first processing unit 222, a second processing unit 224, a volatile memory 226, a non-volatile memory 228, and an arbiter or memory manager 230. In this exemplary embodiment, second processing unit 204 does not include an integrated arbiter. Arbiter 230 is embodied as a separate chip to manage memory accesses of first processing unit 222 and second processing unit 224 to volatile memory 226 and/or non-volatile memory 228. Arbiter 230, processors 222 and 224, and memories 226 and 228 may be capable of performing all of the functions of and/or may include any of the specifications of their counterparts in FIG. 3.

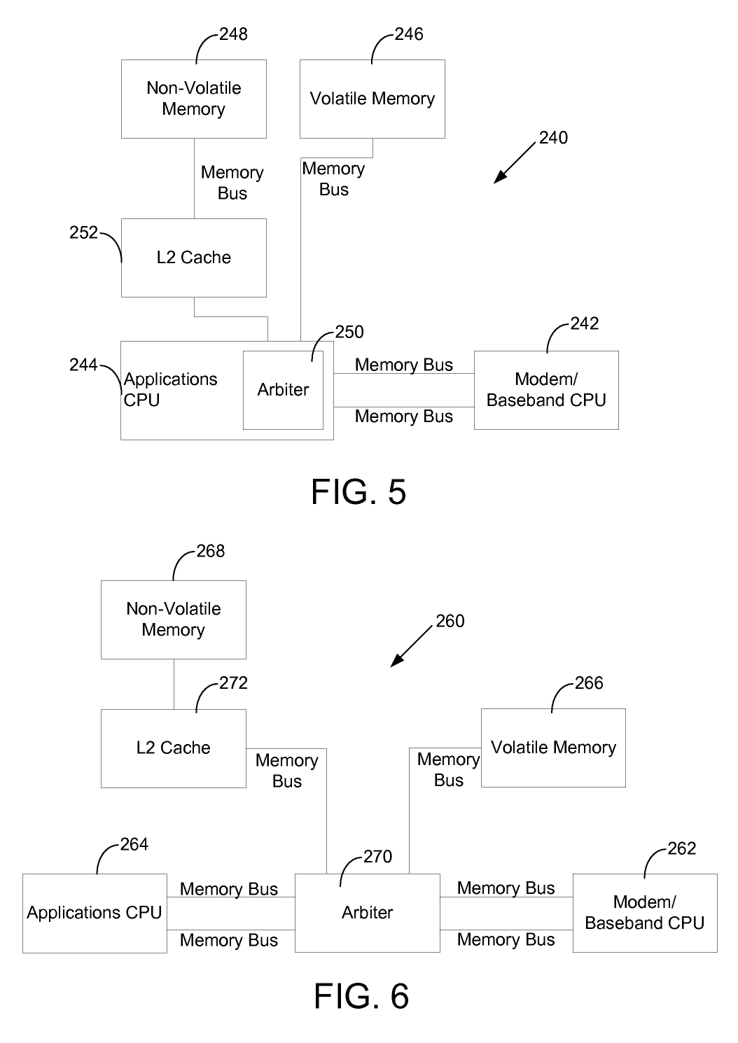

Referring to FIGS. 5 and 6, memory management systems 240 and 260 are similar to memory management systems 200 and 220 of FIGS. 3 and 4, respectively, and are configured to provide memory access to multiple processing units. Memory management system 240 generally includes a first processing unit 242, a second processing unit 244, a volatile memory 246, and a non-volatile memory 248. Second processing unit 244 includes an arbiter or memory manager block 250 to manage memory accesses to volatile memory 246 and/or non-volatile memory 248. Arbiter 250, processors 242 and 244, and memories 246 and 248 may be capable of performing all of the functions of and/or may include any of the specifications of their counterparts in FIG. 3.

Memory management system 260 generally includes a first processing unit 262, a second processing unit 264, a volatile memory 266, a non-volatile memory 268, and an arbiter or memory manager 270. In this exemplary embodiment, second processing unit 264 does not include an integrated arbiter. Arbiter 270 is embodied as a separate chip to manage memory accesses of first processing unit 262 and second processing unit 264 to volatile memory 266 and/or non-volatile memory 268. Arbiter 270, processors 262 and 264, and memories 266 and 268 may be capable of performing all of the functions of and/or may include any of the specifications of their counterparts in FIG. 4.

Memory management systems 240 and 260 each include a cache 252, 272 located between non-volatile memories 248, 268 and arbiters 250, 270. Caches 252 and 272 may be configured to pre-fetch instructions and/or data from non-volatile memory 268 that are likely to be transferred to processing units 242, 262 and/or 244, 264 based on data and/or instructions previously accessed (e.g., sequential data and/or instructions, branch prediction based on instruction and/or data access history, data in blocks around the data requested by a processing unit, etc.). It is noted that according to other exemplary embodiments, a cache may couple volatile memories 246, 266 with first processing units 242, 262 in addition to or instead of caches 252, 272. Further, as an alternative to (or in addition to) cache 252, 272 between memories 248,246,266,268 and arbiters 250,270, one or more caches may be located anywhere between the memories 246,248,266,268 and processing units 242,244,262,266. For example, a cache may be located between arbiter 250,270 and one or more processing units 242,244,262,266. The cache may be a separate component, may be within the same chip as a memory 246,248,266,268, may be within the same chip as arbiter 210, may be within the same chip as a processing unit 242,244,262,266. Further, one or more caches may be located within the same data transfer path between a processing unit 242,244,262,266 and a memory 246,248,266,268.

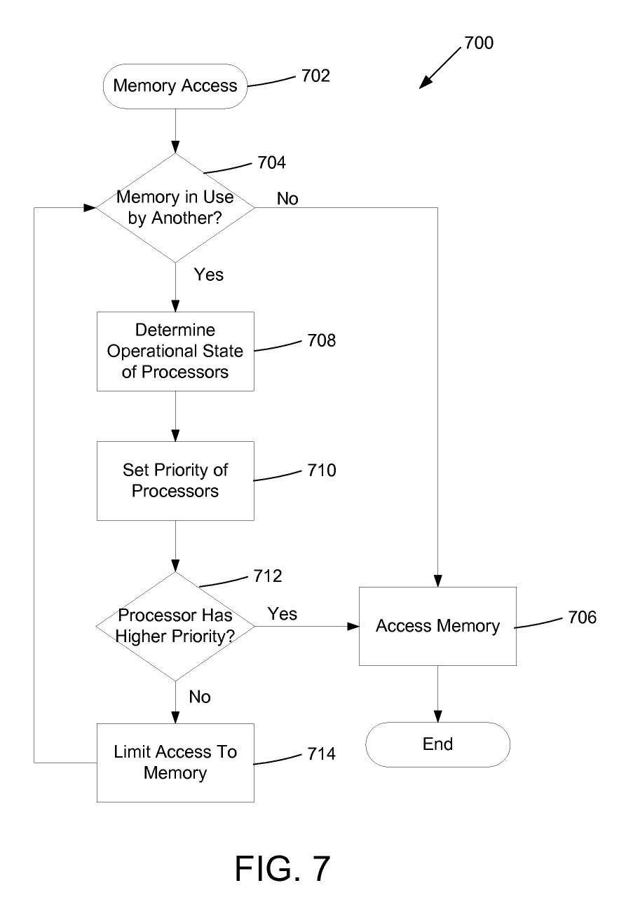

Referring to FIG. 7, a method 700 illustrates a memory management scheme that may be executed by arbiter 210, 230, 250, and/or 270 according to an exemplary embodiment. At a step 702, the system determines that a processing unit is requesting a memory access.

At a step 704, the system determines if the requested memory area is in use or will be in use by a processing unit other than the requester. For example, a memory access instruction may include an encoded representation of the memory (e.g., volatile or non-volatile) and address to access within that memory. If the system determines that requested memory, in the case of a single-port memory, is not and/or will not be used by another processing unit, the requesting processing unit may access the requested memory at a step 706. If the system determines that requested memory address, in the case of a dual-port memory, is not and/or will not be used by another processing unit, the requesting processing unit may access the requested memory at a step 706.

If the system determines that requested address space is being or will be used by another processing unit, the requesting processing unit may proceed to a step 708 to determine what processing unit, if any, should be allowed memory access. At step 708, the system determines the operational state of the processing units, i.e., whether a processing unit is in an operational non-operational state (e.g., a stand-by mode, a low power mode, etc.).

At a step 710, the system determines the priority of the processing units. This priority may be based on the operational state. For example, if the first processing unit is determined to be in an operational state, the arbiter may assign priority to the first processing unit. If the first processing unit is in a non-operational state, the arbiter may assign priority to the second processing unit. The priority may also be based on the general functions of the processing units. For example, the system may assign a higher priority to a processing unit that typically executes communication instructions. The priority may also be based on individual instructions executed by the processing units. For example, a processing unit that is seeking memory access for an instruction related to communications may be assigned a higher priority than a processing unit executing another type of instruction even if the former processing unit does not typically execute communications-related instructions.

At a step 712, the system determines if the requesting processing unit has a higher priority than a processing unit currently accessing or that will access the memory space in question.

If the requester does have a higher priority, the system may halt execution of the memory access instruction of the other processing unit and allow access to the memory by the requester at step 706.

If the requester does not have a higher priority, the system may limit or prevent the requester access to the memory space, at least temporarily, at a step 714. The memory request may be placed in a buffer, queue, or cache until sufficient memory access may be granted.

In addition to halting and/or denying access to memory entirely, step 712 may limit the access to the memory without entirely halting and/or denying access. For example, a second processing unit 242 may have a higher priority than a first processing unit 244, but may require slower access speeds than the first processing unit 244. Here, when processing unit 244 accesses data alone, it may access data at a faster rate (e.g. at every memory cycle), while when processing units 242 and 244 are accessing data at the same time, processing unit 244 may only be allowed to access data at a slower rate (e.g. at a fraction of the memory cycles) (as an example of this, if the memory 246,248 is capable of providing data ten times in a period of time, and the second processing unit 242 only requires accessing the memory six times in that period of time, the first processing unit may be denied access at step 712 at six times within the period, but allowed access at four times within the period).

Referring again to FIGS. 3-6, according to some exemplary embodiments, volatile memory 206 may be have a capacity greater than two megabytes. According to other exemplary embodiments, volatile memory 206 may be have a capacity greater than four megabytes. According to some exemplary embodiments, volatile memory 206 may be have a capacity greater than eight megabytes. According to some exemplary embodiments, volatile memory 206 may be have a capacity greater than eight megabytes. According to some exemplary embodiments, volatile memory 206 may be have a capacity greater than sixteen megabytes. According to some exemplary embodiments, volatile memory 206 may be have a capacity greater than thirty-two megabytes. According to some exemplary embodiments, volatile memory 206 may be have a capacity greater than sixty megabytes. According to some exemplary embodiments, volatile memory 206 may be have a capacity greater than eighty megabytes.

According to some exemplary embodiments, volatile memory 206 may be have a capacity up to about four-hundred megabytes. According to some exemplary embodiments, volatile memory 206 may be have a capacity up to about three-hundred megabytes. According to some exemplary embodiments, volatile memory 206 may be have a capacity up to about two-hundred megabytes. According to some exemplary embodiments, volatile memory 206 may be have a capacity up to about one-hundred megabytes. According to some exemplary embodiments, volatile memory 206 may be have a capacity up to about fifty megabytes. According to some exemplary embodiments, volatile memory 206 may be have a capacity up to about thirty megabytes.

According to some exemplary embodiments, non-volatile memory 208 may be have a capacity greater than two megabytes. According to other exemplary embodiments, non-volatile memory 208 may be have a capacity greater than four megabytes. According to some exemplary embodiments, non-volatile memory 208 may be have a capacity greater than eight megabytes. According to some exemplary embodiments, non-volatile memory 208 may be have a capacity greater than eight megabytes. According to some exemplary embodiments, non-volatile memory 208 may be have a capacity greater than sixteen megabytes. According to some exemplary embodiments, non-volatile memory 208 may be have a capacity greater than thirty-two megabytes. According to some exemplary embodiments, non-volatile memory 208 may be have a capacity greater than sixty megabytes. According to some exemplary embodiments, non-volatile memory 208 may be have a capacity greater than eighty megabytes.

According to some exemplary embodiments, non-volatile memory 208 may be have a capacity up to about forty gigabytes. According to some exemplary embodiments, non-volatile memory 208 may be have a capacity up to about twenty gigabytes. According to some exemplary embodiments, non-volatile memory 208 may be have a capacity up to about ten gigabytes. According to some exemplary embodiments, non-volatile memory 208 may be have a capacity up to about 5 gigabytes. According to some exemplary embodiments, non-volatile memory 208 may be have a capacity up to about one gigabyte. According to some exemplary embodiments, non-volatile memory 208 may be have a capacity up to about five-hundred megabytes. According to some exemplary embodiments, non-volatile memory 208 may be have a capacity up to about four-hundred megabytes. According to some exemplary embodiments, non-volatile memory 208 may be have a capacity up to about four-hundred megabytes. According to some exemplary embodiments, non-volatile memory 208 may be have a capacity up to about three-hundred megabytes. According to some exemplary embodiments, non-volatile memory 208 may be have a capacity up to about two-hundred megabytes. According to some exemplary embodiments, non-volatile memory 208 may be have a capacity up to about one-hundred megabytes. According to some exemplary embodiments, non-volatile memory 208 may be have a capacity up to about fifty megabytes. According to some exemplary embodiments, non-volatile memory 208 may be have a capacity up to about thirty megabytes.

### Illustrative Embodiments

One embodiment of the disclosure relates to a wireless device. The wireless device includes a first chip comprising a volatile memory having a first data port configured to facilitate access to the volatile memory. The wireless device also includes a second chip distinct from the first chip. The second chip includes a first processing unit configured to access data from the volatile memory from the first port to implement functions of the first processing unit. The wireless device also includes a third chip distinct from the first and second chips. The third chip includes a second processing unit configured to access data from the volatile memory from the first port to implement functions of the second processing unit.

Another embodiment of the disclosure relates to a wireless phone device. The wireless phone device includes a memory having a first data port configured to facilitate access to the memory. The wireless phone device also includes a first processing unit configured to access data from the volatile memory. The wireless phone device also includes a second processing unit comprising a second data port configured to allow the second processing unit to directly connect to external memory devices. The second processing unit is configured to access data by way of the second data port. The first processing unit and second processing unit are configured to access data from the first data port of the memory.

Another embodiment of the disclosure relates to a wireless phone device. The wireless phone device includes a first chip comprising a memory having a data port configured to facilitate access to the memory. The memory has a data capacity greater than 8 megabytes. The wireless phone device also includes a second chip distinct from the first chip. The second chip includes a first processing unit configured to access data from the memory. The first processing unit is part of a modem circuit configured to facilitate wireless communications between the device and a wireless voice communication network. The wireless phone device also includes a third chip distinct from the first and second chips. The third chip includes a second processing unit configured to access data from the memory. The second processing unit is configured to control at least one application not related to communication with the wireless communication network. The wireless phone device also includes an arbiter coupled to the data port of the memory and configured to facilitate access of the memory by the first and second processing units. The arbiter is configured to be transparent to the first processing unit and provide the first processing unit access to the memory.

Another embodiment of the disclosure relates to an arbiter configured to allow at least two processing units to share a memory having a data port. The arbiter includes a first data port configured to couple the arbiter to the data port of the memory. The arbiter also includes a second data port that is configured to mimic the data port of the memory and is configured to couple the arbiter to a first processing unit of the at least two processing units. The arbiter also includes logic configured to receive requests for data in the memory from the first and second processing units and to provide data to the first and second processing units in response to the requests. The logic is configured to allow the arbiter to appear to the first processing unit as if the arbiter were a memory device directly coupled to the first processing unit.

### Other Features

Referring back to FIG. 1, portable device 10 may be a mobile computing device capable of executing software programs. The device 10 may be implemented as a combination handheld computer and mobile telephone, sometimes referred to as a smart phone. Examples of smart phones include, for example, Palm® products such as Palm® Treo™ smart phones. Although some embodiments may be described with portable device 10 implemented as a smart phone by way of example, it may be appreciated that the embodiments are not limited in this context. For example, portable device 10 may comprise, or be implemented as, any type of wireless device, mobile station, or portable computing device with a self-contained power source (e.g., battery) such as a laptop computer, ultra-laptop computer, personal digital assistant (PDA), cellular telephone, combination cellular telephone/PDA, mobile unit, subscriber station, user terminal, portable computer, handheld computer, palmtop computer, wearable computer, media player, camera, pager, messaging device, data communication device, and so forth.

Processing circuit 32 of hand-held device 10 may include one or more of a microprocessor 26, second microprocessor 26, image processing circuit 16, display driver 18, a memory (e.g. non-volatile memory—NVM) controller 28, audio driver 22 (e.g. D/A converter, A/D converter, an audio coder and/or decoder (codec), amplifier, etc.), and other processing circuits. Processing circuit 32 can include various types of processing circuitry, digital and/or analog, and may include one or more of a microprocessor, microcontroller, application-specific integrated circuit (ASIC), field programmable gate array (FPGA), or other circuitry configured to perform various input/output, control, analysis, and other functions. In various embodiments, the processing circuit 32 may include a central processing unit (CPU) using any suitable processor or logic device, such as a as a general purpose processor. Processing circuit 32 may include, or be implemented as, a chip multiprocessor (CMP), dedicated processor, embedded processor, media processor, input/output (I/O) processor, co-processor, a microprocessor such as a complex instruction set computer (CISC) microprocessor, a reduced instruction set computing (RISC) microprocessor, and/or a very long instruction word (VLIW) microprocessor, a processor implementing a combination of instruction sets, a controller, a microcontroller, an application specific integrated circuit (ASIC), a field programmable gate array (FPGA), a programmable logic device (PLD), or other processing device in accordance with the described embodiments.

Processing circuit 32 may be configured to digitize data, to filter data, to analyze data, to combine data, to output command signals, and/or to process data in some other manner. Processing circuit 32 may be configured to perform digital-to-analog conversion (DAC), analog-to-digital conversion (ADC), modulation, demodulation, encoding, decoding, encryption, decryption, etc. Processing circuit 32 (e.g. microprocessor 26) may be configured to execute various software programs such as application programs and system programs to provide computing and processing operations for device 10.

Processing circuit 32 may also include a memory that stores data. Processing circuit may include only one of a type of component (e.g. one microprocessor), or may contain multiple components of that type (e.g. multiple microprocessors). Processing circuit 32 could be composed of a plurality of separate circuits and discrete circuit elements. In some embodiments, processing circuit 32 will essentially comprise solid state electronic components such as a microprocessor (e.g. microcontroller). Processing circuit 32 may be mounted on a single board in a single location or may be spread throughout multiple locations which cooperate to act as processing circuit 32. In some embodiments, processing circuit 32 may be located in a single location and/or all the components of processing circuit 32 will be closely connected.

Components shown as part of a single processing circuit 32 in the figures may be parts of separate processing circuits in various embodiments covered by the claims unless limited by the claim to a single processing circuit (e.g. location circuit 24 may be part of a separate assembly having a separate microprocessor that interfaces with processing circuit 32 through data port 40).

Hand-held device 10 may also include a network transceiver 44. Transceiver 44 may operate using one or more of a LAN standard, a WLAN standard, a Bluetooth standard, a Wi-Fi standard, an Ethernet standard, and/or some other standard. Network transceiver 44 may be a wireless transceiver such as a Bluetooth transceiver and/or a wireless Ethernet transceiver. Wireless transceiver 44 may operate using an IEEE 802.11 standard. Hand-held device 10 may also include an external device connector 40 (such as a serial data port) for transferring data. External device connector 40 may also serve as the connector 52 to an external power supply. Hand-held device may contain more than one of each of transceiver 44 and external device connector 40. For example, network transceiver 44 may include both a Bluetooth and an IEEE 802.11 transceiver.

Network transceiver 44 may be arranged to provide voice and/or data communications functionality in accordance with different types of wireless network systems. Examples of wireless network systems may include a wireless local area network (WLAN) system, wireless metropolitan area network (WMAN) system, wireless wide area network (WWAN) system, and so forth. Examples of wireless network systems offering data communication services may include the Institute of Electrical and Electronics Engineers (IEEE) 802.xx series of protocols, such as the IEEE 802.11a/b/g/n series of standard protocols and variants (sometimes referred to as “WiFi”), the IEEE 802.16 series of standard protocols and variants (sometimes referred to as “WiMAX”), the IEEE 802.20 series of standard protocols and variants, and so forth.

Hand-held device 10 may be capable of operating as a mobile phone. The mobile phone may use transceiver 44 and/or may use a cellular transceiver 36. Cellular transceiver 36 may be configured to operate as an analog transceiver, a digital transceiver (e.g. a GSM transceiver, a TDMA transceiver, a CDMA transceiver), or some other type of transceiver. Cellular transceiver 36 may be configured to transfer data (such as image files) and may be used to access the Internet 42 in addition to allowing voice communication. Cellular transceiver 36 may be configured to use one or more of an EV-technology (e.g. EV-DO, EV-DV, etc.), an EDGE technology, a WCDMA technology, and/or some other technology.

Transceiver 44 may be arranged to perform data communications in accordance with different types of shorter range wireless systems, such as a wireless personal area network (PAN) system. One example of a wireless PAN system offering data communication services includes a Bluetooth system operating in accordance with the Bluetooth Special Interest Group (SIG) series of protocols, including Bluetooth Specification versions v1.0, v1.1, v1.2, v2.0, v2.0 with Enhanced Data Rate (EDR), etc.—as well as one or more Bluetooth Profiles, etc. Other examples may include systems using an infrared technique.

Cellular transceiver 36 may provide voice communications functionality in accordance with different types of cellular radiotelephone systems. Examples of cellular radiotelephone systems may include Code Division Multiple Access (CDMA) cellular radiotelephone communication systems, Global System for Mobile Communications (GSM) cellular radiotelephone systems, North American Digital Cellular (NADC) cellular radiotelephone systems, Time Division Multiple Access (TDMA) cellular radiotelephone systems, Extended-TDMA (E-TDMA) cellular radiotelephone systems, Narrowband Advanced Mobile Phone Service (NAMPS) cellular radiotelephone systems, third generation (3G) systems such as Wide-band CDMA (WCDMA), CDMA-2000, Universal Mobile Telephone System (UMTS) cellular radiotelephone systems compliant with the Third-Generation Partnership Project (3GPP), and so forth.

In addition to voice communications functionality, the cellular transceiver 36 may be arranged to provide data communications functionality in accordance with different types of cellular radiotelephone systems. Examples of cellular radiotelephone systems offering data communications services may include GSM with General Packet Radio Service (GPRS) systems (GSM/GPRS), CDMA/1xRTT systems, Enhanced Data Rates for Global Evolution (EDGE) systems, Evolution Data Only or Evolution Data Optimized (EV-DO) systems, Evolution For Data and Voice (EV-DV) systems, High Speed Downlink Packet Access (HSDPA) systems, High Speed Uplink Packet Access (HSUPA), and so forth.

Hand-held device 10 may include one or more user input devices 31 (e.g. button, switch, touch screen, keyboard, keypad, voice command circuit, etc.) for registering commands from a user on device 10. Some or all of user input devices 31 may interface with a switch control circuit (not shown) configured to interpret which switches have been actuated. User input device 31 may include an alphanumeric keyboard. The keyboard may comprise, for example, a QWERTY key layout and an integrated number dial pad. A keyboard integrated into a hand-held device would typically be a thumb keyboard. User input device 31 may also include various keys, buttons, and switches such as, for example, input keys, preset and programmable hot keys, left and right action buttons, a navigation button such as a multidirectional navigation button, phone/send and power/end buttons, preset and programmable shortcut buttons, a volume rocker switch, a ringer on/off switch having a vibrate mode, and so forth. Any of user input devices 31 may be concealable behind a body (e.g. a sliding body, a flip-out body, etc.) such that they are hidden when the body is in a first position and visible when the body is in the second position.

Hand-held device 10 may include one or more location determining circuits 24 (e.g. a GPS circuit and/or a cell-based location determining circuit) configured to determine the location of device 10. Device 10 may be configured to receive inputs from more than one location determining circuit 24. These inputs can be compared such that both are used, one (e.g. a cell-based system) can be used primarily when the other (e.g. GPS) is unable to provide reliable location information, or can have some other functional relationship.

Device 10 may use one or more different location determining techniques to derive the location of the device 10 based on the data from location determining circuit 24.

For example, device 10 may use one or more of Global Positioning System (GPS) techniques, Cell Global Identity (CGI) techniques, CGI including timing advance (TA) techniques, Enhanced Forward Link Trilateration (EFLT) techniques, Time Difference of Arrival (TDOA) techniques, Angle of Arrival (AOA) techniques, Advanced Forward Link Trilateration (AFTL) techniques, Observed Time Difference of Arrival (OTDOA), Enhanced Observed Time Difference (EOTD) techniques, Assisted GPS (AGPS) techniques, hybrid techniques (e.g., GPS/CGI, AGPS/CGI, GPS/AFTL or AGPS/AFTL for CDMA networks, GPS/EOTD or AGPS/EOTD for GSM/GPRS networks, GPS/OTDOA or AGPS/OTDOA for UMTS networks), and so forth.

Device 10 may be arranged to operate in one or more position determination modes including, for example, a standalone mode, a mobile station (MS) assisted mode, and/or a MS-based mode. In a standalone mode, such as a standalone GPS mode, the mobile computing device 100 may be arranged to autonomously determine its position without network interaction or support. When operating in an MS-assisted mode or an MS-based mode, however, device 10 may be arranged communicate over a radio access network (e.g., UMTS radio access network) with a position determination entity (PDE) such as a location proxy server (LPS) and/or a mobile positioning center (MPC).

In an MS-assisted mode, such as an MS-assisted AGPS mode, the PDE may be arranged to determine the position of the mobile computing device. In an MS-based mode, such as an MS-based AGPS mode, device 10 may be arranged to determine its position with only limited periodic assistance from the PDE. In various implementations, device 10 and the PDE may be arranged to communicate according a suitable MS-PDE protocol (e.g., MS-LPS or MS-MPC protocol) such as the TIA/EIA standard IS-801 message protocol for MS-assisted and MS-based sessions in a CDMA radiotelephone system.

When assisting device 10, the PDE may handle various processing operations and also may provide information to aid position determination. Examples of assisting information may include satellite-based measurements, terrestrial-based measurements, and/or system-based measurements such as satellite almanac information, GPS code phase measurements, ionospheric data, ephemeris data, time correction information, altitude estimates, timing offsets, forward/reverse link calibration, and so forth.

In various implementations, the assisting information provided by the PDE may improve the speed of satellite acquisition and the probability of a position fix by concentrating the search for a GPS signal and/or may improve the accuracy of position determination. Each position fix or series of position fixes may be available at device 10 and/or at the PDE depending on the position determination mode. In some cases, data calls may be made and assisting information may be sent to device 10 from the PDE for every position fix. In other cases, data calls may be made and assistance information may be sent periodically and/or as needed.

Hand-held device 10 may include one or more audio circuits 20 (e.g. speakers, microphone, etc.) for providing or receiving audio information to or from a user. In one example, hand-held device 10 includes a first speaker 20 designed for regular phone operation. Hand-held device 10 may also include a second speaker 20 for louder applications such as speaker phone operation, music or other audio playback (e.g. an mp3 player application), etc. Hand-held device 10 may also include one or more audio ports 20 (e.g. a headphone connector) for output to an external speaker and/or input from an external microphone. Audio circuit 20 may be under the control of one or more audio drivers 22 which may include D/A converters and/or an amplifier.

Hand-held device 10 may include a camera 12 for taking pictures using device 10. Camera 12 may include a CCD sensor, a CMOS sensor, or some other type of image sensor capable of obtaining an image (particularly, images sensors capable of obtaining an image formed as an array of pixels). The image sensor may have a resolution of at least about 65,000 pixels or at least about 1 megapixel. In some embodiments, the image sensor may have a resolution of at least about 4 megapixels. Camera 12 may also include read-out electronics for reading data from the image sensor. Image processing circuit 16 may be coupled to the camera 12 for processing an image obtained by the camera. This image processing may include format conversion (e.g. RGB to YCbCr), white balancing, tone correction, edge correction, red-eye reduction, compression, CFA interpolation, etc. Image processing circuit 16 may be dedicated hardware that has been optimized for performing image processing.

Hand-held device 10 may include a display 14 for displaying information to a user. Display 14 could be one or more of an LCD display (e.g. a touch-sensitive color thin-film transistor (TFT) LCD screen), an electroluminescent display, a carbon-nanotube-based display, a plasma display, an organic light emitting diode (OLED) display, and some other type of display. Display 14 may be a touch screen display such that a user may input commands by approaching (e.g. touching) display 14 (including touch screens that require a specialized device to input information). Display 14 may be a color display (e.g., 16 or more bit color display) or may be a non-color (e.g. monotone) display. Display 14 may be controlled by a display driver 18 that is under the control of a microprocessor 26. In some embodiments, display 14 may be used with a stylus. Display 14 may be used as an input to a handwriting recognizer application.

Hand-held device 10 may include a dedicated memory 34 fixed to device 10. Memory 34 may be implemented using any machine-readable or computer-readable media capable of storing data such as erasable or non-erasable memory, writeable or re-writeable memory, and so forth. Dedicated memory 34 may be a non-volatile memory, may be a volatile memory, or may include both volatile and non-volatile memories. Examples of machine-readable storage media may include, without limitation, random-access memory (RAM), dynamic RAM (DRAM), Double-Data-Rate DRAM (DDRAM), synchronous DRAM (SDRAM), static RAM (SRAM), read-only memory (ROM), programmable ROM (PROM), erasable programmable ROM (EPROM), electrically erasable programmable ROM (EEPROM), flash memory (e.g., NOR or NAND flash memory), content addressable memory (CAM), polymer memory (e.g., ferroelectric polymer memory), phase-change memory, ovonic memory, ferroelectric memory, silicon-oxide-nitride-oxide-silicon (SONOS) memory, magnetic or optical cards, or any other type of media suitable for storing information. In one embodiment, fixed memory 34 is a non-volatile memory.

Although the memory 34 is shown as being separate from and external to processing circuit 32 some portion or the entire memory 34 may be included on the same integrated circuit as processing circuit 32 (e.g. the same integrated circuit as microprocessor 26).

Hand-held device 10 may include a removable memory port 38 configured to receive a removable memory medium, and/or other components. Removable memory port 38 may also serve as an external device connector 40. For example, removable memory port may be an SDIO card slot which can be used to receive memory cards, receive cards input and/or output data, and combined cards having both memory and input/output functions.

Memory 34 and/or memory 38 may be arranged to store one or more software programs to be executed by processing circuit 32.

Dedicated memory 34 and removable memory 38 may be connected to and/or under the control of a common memory controller 28 such as a non-volatile memory controller. Memory controller 28 may be configured to control reading of data to and writing of data from dedicated memory 34 and/or removable memory 38.

Handheld device 10 may be configured to connect to one or more servers 46,48 via a network 42 (such as the Internet) using one or more of network transceiver 44, cellular transceiver 36, and external device connector 40.

Hand-held device 10 may also include a power supply circuit 52 configured to regulate power supply in hand-held device 10. Power supply circuit 52 may be configured to do one or more of control charging of battery 56, to communicate the amount of power remaining in battery 56, determine and/or communicate whether an external power supply is connected, switch between the external power supply and the battery, etc. Battery 56 may be a rechargeable battery and may be removable or may be fixed to device 10. Battery 56 may be formed from any number of types of batteries including silver-based batteries (e.g. silver-zinc, magnesium-silver-chloride, etc.), a lithium-based battery (e.g. lithium-ion, lithium-polymer, etc.), a nickel-based battery (nickel-cadmium, nickel-metal-hydride, etc.), zinc-based batteries (e.g. silver-zinc, carbon-zinc, etc.), etc. External power supply connector 34 may be configured to be connected to a direct current source, an alternating current source, or both DC and AC sources.

Device 10 may have an optical viewfinder (not shown), may use display 14 as a digital viewfinder, may include some other type of view finder, may include multiple types of view finders, or may not include a view finder.

Device 10 may be configured to connect to the Internet 42, which may be a direct connection (e.g. using cellular transceiver 36, external device connector 40, or network transceiver 44) or may be an indirect connection (e.g. routed through external device 50). Device 10 may receive information from and/or provide information to the Internet. Device 10 may include a web browser configured to display information received from the Internet (including information which may be optimized by the browser for display on portable device 10). Device 10 may connect to one or more remote servers 46,48 using the Internet. Device 10 could also connect to another personal electronic device 50 by way of the Internet.

Device 10 may comprise an antenna system (not illustrated) for transmitting and/or receiving electrical signals. Each of the transceivers 36,44 and/or location circuit 24 may include individual antennas or may include a common antenna system. The antenna system may include or be implemented as one or more internal antennas and/or external antennas.

Portable device 10 may comprise a subscriber identity module (SIM) coupled to processing circuit 32. The SIM may comprise, for example, a removable or non-removable smart card arranged to encrypt voice and data transmissions and to store user-specific data for allowing a voice or data communications network to identify and authenticate the user. The SIM may store data such as personal settings specific to the user.

Referring to FIG. 2, device 10 and/or processing circuit 32 may be configured to run any number of different types of applications. Examples of application programs may include, for example, a phone application 130 (e.g. a telephone application, a voicemail application, a VoIP application, etc.), a messaging application 102 (e.g. an e-mail application, an instant message (IM) application, a short message service (SMS) application, a multimedia message service (MMS) application), a web browser application 128, a personal setting application 110 (e.g. a personal information manager (PIM) application), a contact management application 118, a calendar application 116 (e.g. a calendar application, a scheduling application, etc.), a task management application 122, a document application (e.g. a word processing application, a spreadsheet application, a slide application, a document viewer application, a database application, etc.), a location application 114 (e.g. a positioning application, a navigation application, etc.), an image application 112 (e.g. a camera application such as a digital camera application and/or a video camera application, an image management application, etc.) including media player applications (e.g. a video player application, an audio player application, a multimedia player application, etc.), a gaming application, a handwriting recognition application, and so forth. The application software may provide a graphical user interface (GUI) to communicate information between the portable device 10 and a user.

Device 10 may include a location application 114. Location application 114 may be configured to calculate the current position (e.g. the rough current position) of device 10 based on data received from one or more location circuits 24. Location application 114 may be provided with map information such that it can translate coordinate positions into map positions (and vice versa). Location application 114 may be configured to provide navigational information to a user such as turn by turn directions.

Device 10 may include personal organizer applications such as a calendar application 116, a contacts application 118, and a task application (not illustrated). Calendar application 116 may allow a user to schedule events, set alarms for events, and store a wide variety of information for events (e.g. name of the event, location of the event, other attendees of the event, etc.). Contacts application 118 may allow a user to save contact information for a contact such as phone number information (which may be shared with a phone application 130), address information, group information (e.g. which user created group or groups the contact belongs to), and other information about the contact. The task application allows a user to keep track of pending and/or completed tasks.

Device 10 may include an internal clock application 124 that keeps track of time information (such as current time of day and/or date), time zone information, daylight savings time information, etc. Clock application 124 may be a program running based on data from an internal clock of microprocessor 26, data from a separate clock/timing circuit, or data from some other circuit.

Device 10 may also include one or more network connection protocol applications 126 that allow a user to transfer data over one or more networks. Network application 126 may be configured to allow device 10 to access a remote device such as server 46,48.

Device 10 may include an Internet browser application 128 that allows a user to browse the internet. The Internet browser application may be configured to alter the data received from Internet sites so that the data can be easily viewed on portable device 10.

Device 10 may include a phone application 130 configured to allow a user to make phone calls. Phone application 130 may use contact information from contact application 118 to place phone calls.

Device 10 may also include one or more messaging applications 102 that allow a user to send and/or receive messages such as text messages, multi-media messages, e-mails, etc. E-mail messages may come from a server which may use a Push technology and/or may use a pull technology (e.g. POP3, IMAP, etc.).

Any of the information discussed above for any of the applications (e.g. applications 102-128) may be added to or otherwise associated with an image file.

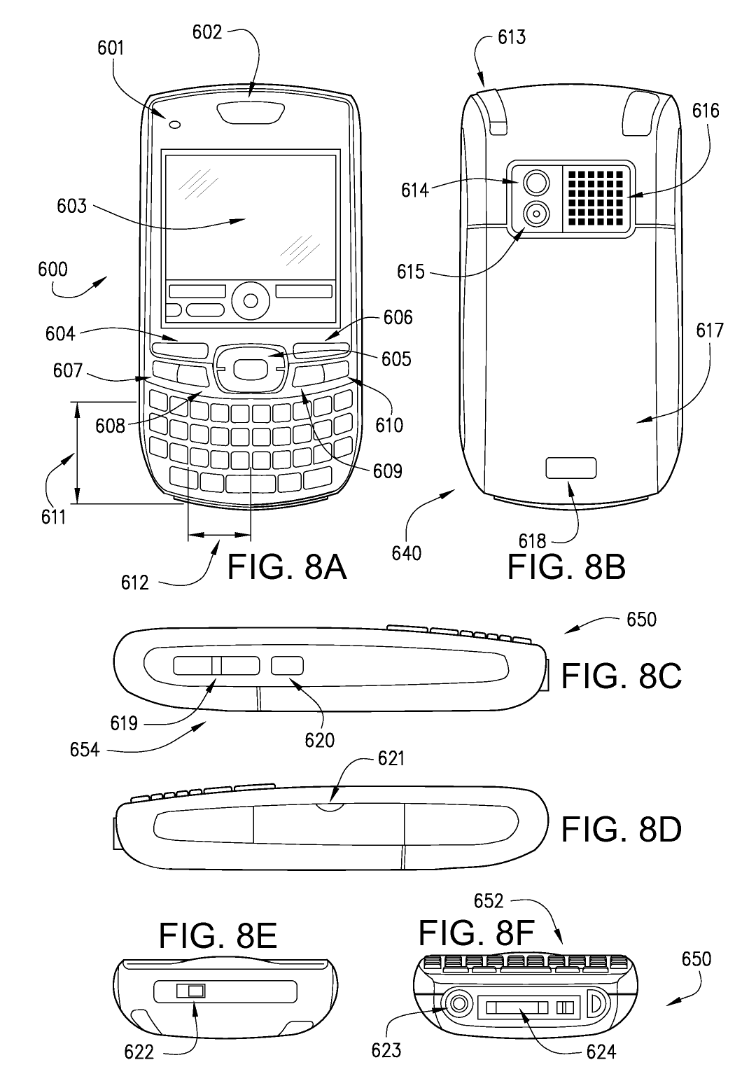

Referring to FIGS. 1 and 8A-8F, a hand-held portable computing device 600 (e.g. smartphone) includes a number of user input devices 31. The user input devices include a send button 604 configured to select options appearing on display 603 and/or send messages, a 5-way navigator 605 configured to navigate through options appearing on display 603, a power/end button 606 configured to select options appearing on display 603 and to turn on display 603, a phone button 607 usable to access a phone application screen, a calendar button 608 usable to access a calendar application screen, a messaging button 609 usable to access a messaging application screen, an applications button 610 usable to access a screen showing available applications, a thumb keyboard 611 (which includes a phone dial pad 612 usable to dial during a phone application), a volume button 619 usable to adjust the volume of audio output of device 600, a customizable button 620 which a user may customize to perform various functions, a ringer switch 622 usable to switch the smartphone from one mode to another mode (such as switching from a normal ringer mode to a meeting ringer mode), and a touch screen display 603 usable to select control options displayed on display 603. Touch screen display 603 is also a color LCD display 14 having a TFT matrix.

Smartphone 600 also includes audio circuits 20. The audio circuits 20 include phone speaker 602 usable to listen to information in a normal phone mode, external speaker 616 louder than the phone speaker (e.g. for listening to music, for a speakerphone mode, etc.), headset jack 623 to which a user can attach an external headset which may include a speaker and/or a microphone, and microphone 625 which can be used to pick up audio information such as the user's end of a conversation during a phone call.

Smartphone 600 also includes a status indicator 601 that can be used to indicate the status of Smartphone 600 (such as messages pending, charging, low battery, etc.), a stylus slot 613 for receiving a stylus such as a stylus usable to input data on touch screen display 603, a digital camera 615 (see camera 12) usable to capture images, a mirror 614 positioned proximate camera 615 such that a user may view themselves in mirror 614 when taking a picture of themselves using camera 615, a removable battery 618 (see battery 56), and a connector 624 (see external data connector 40 and external power supply 34) which can be used to connect device 600 to either (or both) an external power supply such as a wall outlet or battery charger or an external device such as a personal computer, a gps unit, a display unit, or some other external device.

Smartphone 600 also includes an expansion slot 621 (see removable memory 38) which may be used to receive a memory card and/or a device which communicates data through slot 621, and a SIM card slot 617, located behind battery 618, configured to receive a SIM card or other card that allows the user to access a cellular network.

In various embodiments device 10 and device 600 may include a housing 640. Housing 640 could be any size, shape, and dimension. In some embodiments, housing 640 has a width 652 (shorter dimension) of no more than about 200 mm or no more than about 100 mm. According to some of these embodiments, housing 640 has a width 652 of no more than about 85 mm or no more than about 65 mm. According to some embodiments, housing 640 has a width 652 of at least about 30 mm or at least about 50 mm. According to some of these embodiments, housing 640 has a width 652 of at least about 55 mm.

In some embodiments, housing 640 has a length 654 (longer dimension) of no more than about 200 mm or no more than about 150 mm. According to some of these embodiments, housing 640 has a length 654 of no more than about 135 mm or no more than about 125 mm. According to some embodiments, housing 640 has a length 654 of at least about 70 mm or at least about 100 mm. According to some of these embodiments, housing 640 has a length 654 of at least about 110 mm.

In some embodiments, housing 640 has a thickness 650 (smallest dimension) of no more than about 150 mm or no more than about 50 mm. According to some of these embodiments, housing 640 has a thickness 650 of no more than about 30 mm or no more than about 25 mm. According to some embodiments, housing 640 has a thickness 650 of at least about 10 mm or at least about 15 mm. According to some of these embodiments, housing 640 has a thickness 650 of at least about 50 mm.

While described with regards to a hand-held device, many embodiments are usable with portable devices which are not handheld and/or with non-portable devices/systems.

The various single applications discussed above may be performed by multiple applications where more than one application performs all of the functions discussed for the application or where one application only performs some of the functions discussed for the application. For example, the image application 112 may be divided into an image capturing application and a separate image viewing application. Also, more than one application may be included on device 10 that is capable of displaying images as described for image application 112.

Further, while shown as separate applications above, many of the above listed applications can be combined into single applications that perform all or some of the functions listed for more than one of the applications discussed above.

While some components in FIG. 1 were discussed as being singular and others were discussed as being plural, the invention is not limited to devices having these same numbers of each type of component. Embodiments are conceived where each combination of plural and singular components exist.

In some embodiments, the various components shown in FIG. 1 may be combined in a single component. For example, in some embodiments, removable memory 38 may also be an external device connector 40 (such as an SDIO card slot which can be used to receive memory cards, input and/or output data, and combined devices having both memory and input/output functions). As another example, in some embodiments, a single connector could serve as both an external device connector 40 and as a connection to an external power supply 34.

Also, in some embodiments, the function of various claim components shown in FIG. 1 may be performed by a combination of distinct electrical components. For instance, a location circuit 24 may have a separate microprocessor that works in combination with the main microprocessor 26 of the system to perform the functions of the processing circuit 32. As another example, image processing circuit 16 may make use of the electronics of camera 12 to perform image processing, while also having other, discrete electronic components.

What is claimed is:

1. A wireless device, comprising:
a memory having at least one data port configured to facilitate access to the memory;
a first processing unit, the first processing unit configured to access data from the memory to implement functions of the first processing unit;
a second processing unit, the second processing unit configured to access data from the memory to implement functions of the second processing unit; and
an arbiter configured to retrieve data from the memory using at least the at least one data port of the memory, the arbiter configured to provide data to the first processing unit and the second processing unit;
wherein the first processing unit is located on a separate chip than the arbiter and is configured to interact with the arbiter as if the arbiter was the memory.

2. The wireless device of claim 1, wherein the first and second processing units are microprocessors.

3. The wireless device of claim 2, wherein the memory comprises a random access memory.

4. The wireless device of claim 1, wherein the first processing unit is part of a modem circuit configured to facilitate wireless communications between the device and a wireless communication network, and the second processing unit is configured to provide at least one function not related to communication with the wireless communication network.

5. The wireless device of claim 1, wherein the second processing unit and the arbiter are formed in a common chip.

6. The wireless device of claim 1, wherein the arbiter is transparent to the first processing unit.

7. The wireless device of claim 1, wherein the arbiter is configured such that it assigns a priority to data transfer by the first processing unit, and wherein the device further comprises a data buffer between the arbiter and the second processing unit.

8. The wireless device of claim 7, wherein the data buffer comprises a cache.

9. The wireless device of claim 7, wherein the device is configured to pre-fetch data from the non-volatile memory that is likely to be transferred to the second processing unit based on data previously accessed by the second processing unit.

10. The wireless device of claim 1, wherein the arbiter is configured to limit access to the memory such that it will prevent transfer of data in response to a request by the first processing unit to access an area of the memory assigned to the second processing unit.

11. The wireless device of claim 1, wherein the arbiter is configured to facilitate sharing of access to at least two memories by the first and second processing units.

12. The wireless device of claim 11, wherein the at least two memories comprise at least one non-volatile memory and at least one volatile memory.

13. The wireless device of claim 1, wherein the memory is configured to provide a data transfer rate that is faster than the data transfer rate required by the first processing unit, and wherein the arbiter is configured such that it assigns a priority to data transfer by the first processing unit.

14. The wireless device of claim 1, wherein data transfer between the first processing unit and the memory is configured to occur at a rate that is no more than about 500 clock cycles longer than an amount of time it would take to transfer the data directly from the memory to the first processing unit.

15. The wireless device of claim 1, wherein the arbiter is configured to determine whether the first processing unit is in an operational state, and to assign priority to the second processing unit when the first processing unit is not in the operational state.

16. The wireless device of claim 1, wherein the arbiter is configured to determine whether the first processing unit is in a non-operational state, and configured to, when the non-operational state is detected, provide an output to the first processing unit comparable to the output of the memory when the non-operational state is detected.

17. The wireless device of claim 1, wherein the memory has a memory capacity greater than two megabytes.

18. A wireless phone device, comprising:
a first chip comprising a memory having a data port configured to facilitate access to the memory, the memory having a data capacity greater than 8 megabytes;
a second chip distinct from the first chip, the second chip comprising a first processing unit, the first processing unit configured to access data from the memory, the first processing unit being part of a modem circuit configured to facilitate wireless communications between the device and a wireless voice communication network; and
a third chip distinct from the first and second chips, the third chip comprising a second processing unit, the second processing unit configured to access data from the memory, the second processing unit is configured to control at least one application not related to communication with the wireless communication network;
an arbiter coupled to the data port of the memory and configured to facilitate access of the memory by the first and second processing units, the arbiter being configured to be transparent to the first processing unit and to provide the first processing unit access to the memory.

19. The wireless device of claim 18, wherein
the memory of the first chip is a non-volatile memory;
the device further comprises a fourth chip comprising a volatile memory, the volatile memory comprising a data port configured to allow access to data stored by the volatile memory;
the arbiter is coupled to the data port of the volatile memory, and is configured to facilitate access to the volatile memory by the first and second processing units; and
the device further comprises a data buffer between the second processing unit and at least one of the non-volatile memory and the volatile memory.

20. The wireless device of claim 19, wherein the data buffer comprises a cache incorporated into a same chip as the arbiter.

21. The wireless device of claim 18, further comprising a fourth chip comprising the arbiter.

22. The wireless device of claim 18, wherein the second processing unit comprises the arbiter.

23. The wireless device of claim 18, wherein the arbiter is configured to assign priority to requests for data from the memory based on an identity of a portion of the memory being accessed.

24. An arbiter configured to allow at least two processing units to share a memory having a data port, the arbiter comprising:
a first data port configured to couple the arbiter to the data port of the memory;
a second data port that is configured to mimic the data port of the memory and is configured to couple the arbiter to a first processing unit of the at least two processing units;
logic configured to receive requests for data in the memory from the first and second processing units and to provide data to the first and second processing units in response to the requests, the logic configured to allow the arbiter to appear to the first processing unit as if the arbiter were a memory device directly coupled to the first processing unit.
